(19) United States
(12) Patent Application Publication
(10) Pub. No.: US 2023/0330826 A1
(43) Pub. Date: Oct. 19, 2023

(54) Chisel and tool fitting

(71) Applicant: Hilti Aktiengesellschaft, Schaan (LI)

(72) Inventor: Steffen GEIGER, Muenchen (DE)

(21) Appl. No.: 18/028,986

(22) PCT Filed: Sep. 20, 2021
(86) PCT No.: PCT/EP2021/075765

§ 371 Date: Mar. 28, 2023

(30) Foreign Application Priority Data
Sep. 30, 2020 (EP) 20199142.9

(51) Int. Cl. B25D 17/02; B25D 17/08

(52) U.S. Cl. CPC B25D 17/02; B25D 17/088; B25D 2217/0007; B25D 2217/0034

(57) ABSTRACT

Chisel, in particular for a jackhammer, wherein the chisel has a free shank via which the chisel can be inserted along a working axis into an insertion sleeve of a tool fitting, wherein the free shank has a hexagonal cross section at least in certain portions, and wherein at least one guide segment, which modifies the hexagonal cross section and extends along the working axis, is formed on a surface of the free shank.

The present invention relates to a chisel, in particular for a rotary hammer and/or jackhammer. The chisel has a free shank via which the chisel can be inserted along a working axis into an insertion sleeve of a tool fitting. The free shank has a hexagonal cross section at least in certain portions. The present invention also relates to a tool fitting for receiving a percussive and/or rotating tool, in particular a chisel, coaxially to a working axis of the tool fitting. The tool fitting has a basic body with an insertion sleeve into which the tool can be inserted by a free shank. The insertion sleeve is equipped with a hexagonal cross section at least in certain portions.

### BACKGROUND

Such chisels are known in principle from the prior art and are used, for example, in the form of pointed chisels, flat chisels or spade chisels. Shanks having a hexagonal cross section are typically referred to as HEX shanks. Corresponding tool fittings are also known from the prior art.

### SUMMARY OF THE INVENTION

It is an object of the present invention to provide a chisel and a tool fitting that promote handling in a comparatively secure and simple manner.

The present disclosure provides with regard to the chisel that at least one guide segment, which modifies the hexagonal cross section and extends along the working axis, is formed on a surface of the free shank.

The invention includes the finding that a chisel when being inserted into a tool fitting—more precisely, the free shank of the chisel is inserted into a corresponding insertion sleeve of the tool fitting—frequently jams. The fact that at least one guide segment which modifies the hexagonal cross section is formed on a surface of the free shank results in the risk of jamming of the free shank being reduced. This applies both during insertion and during extraction of the chisel. At the same time, it has been observed that—if the insertion sleeve of the tool fitting is provided with a corresponding supporting portion—the entry of metallic abrasions from inside a jackhammer into the edges of the hexagonal cross section of the insertion sleeve can be reduced. The pairing of the guide segment and the supporting portion means that, when inserting the chisel, such metallic abrasions are as it were stripped off. As a result, the risk of clogging of a locking device of the chisel is considerably reduced. This leads in practice to the fact that the chisel according to the invention can be unlocked considerably more easily than previously known chisels.

In a particularly preferred embodiment, the shank has at least one locking groove for locking the shank in the insertion sleeve. The locking groove preferably extends parallel to the working axis. The locking groove is preferably assigned to a locking device of a tool fitting. The locking device of the tool fitting can, for example, have a ball which projects through a locking cutout, which is preferably formed in a basic body of the tool fitting, into the locking groove of the chisel. In this way, an axial movement of the chisel along the working axis can be limited.

It has been found to be advantageous if the chisel has a working side, and the guide segment, with respect to the working axis and in a viewing direction from the working side toward the shank, begins at the earliest at the height of the locking groove. In a particularly preferred embodiment, the guide segment is situated only on a side of the locking groove facing away from the working side.

In a further preferred embodiment, the guide segment has a planar surface. It has been found to be advantageous if the planar surface, with respect to the working axis, extends tangentially and, in the circumferential direction, is placed centrally over an edge of the hexagonal cross section.

Alternatively or additionally, the guide segment can have, with respect to the working axis, a concavely curved surface. It has been found to be advantageous if this surface is arranged in the circumferential direction centrally between two adjacent edges of the hexagonal cross section on a flank of hexagonal cross section.

In a particularly preferred embodiment, six guide segments are provided which are arranged uniformly along a circumference. In a particularly preferred embodiment, precisely six guide segments are provided.

The present invention also provides with regard to the tool fitting that at least one supporting portion, which extends parallel to the working axis of the tool fitting and which preferably serves to support the shank, is formed on an inner surface of the insertion sleeve.

It has been found to be advantageous if the insertion sleeve has at least one locking cutout for locking the shank in the insertion sleeve, wherein the locking cutout extends parallel to the working axis. The locking cutout is preferably part of the locking device already described at the outset.

In a particularly preferred embodiment, there is provision that the insertion sleeve has an inlet opening for the shank, and the supporting portion extends, with respect to the working axis, only on that side of the locking cutout which faces away from the inlet opening.

In a further preferred embodiment, the supporting portion has a planar surface which, with respect to the working axis, extends tangentially and, in the circumferential direction, is placed centrally over an edge of the hexagonal cross section.

Alternatively or additionally, the supporting portion can have, with respect to the working axis, a concavely curved surface. It has been found to be advantageous if this surface is placed centrally between two adjacent edges of the hexagonal cross section in the circumferential direction.

In a particularly preferred embodiment, the tool fitting has six supporting portions which are arranged uniformly along a circumference of the inner surface. It has been found to be advantageous if the supporting portion is formed in one piece with the insertion sleeve.

In a further preferred embodiment, the supporting portion formed in the insertion sleeve corresponds with the guide segment formed on the chisel. In other words, with the chisel inserted, the supporting portion and the guide segment are preferably in contact.

The invention also provides an electric handheld power tool, in particular in the form of a jackhammer or hammer drill, having an above-described chisel and/or an above-described tool fitting.

### BRIEF DESCRIPTION OF THE DRAWINGS

Further advantages will become apparent from the following description of the figures. Various exemplary embodiments of the present invention are illustrated in the figures. The figures, the description and the claims contain numerous features in combination. A person skilled in the art will expediently also consider the features individually and combine them to form useful further combinations.

In the figures, identical and similar components are denoted by the same reference signs. In the figures:

FIG. 1 shows a first preferred exemplary embodiment of a chisel;

FIG. 2 shows a first preferred exemplary embodiment of a tool fitting;

FIG. 3 shows a perspective sectional illustration of the tool fitting;

FIG. 4 shows a cross section of the tool fitting (along the section line A-A in FIG. 3);

FIG. 5 shows a second preferred exemplary embodiment of a chisel;

FIG. 6 shows a second preferred exemplary embodiment of a tool fitting in a perspective sectional illustration; and

FIG. 7 shows a cross section of the tool fitting (along the section line A-A in FIG. 6).

### DETAILED DESCRIPTION

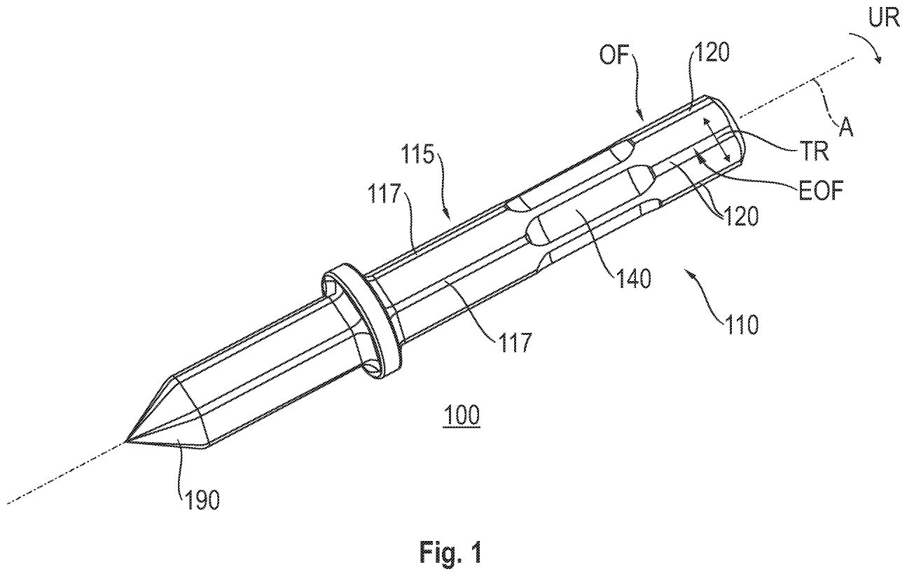

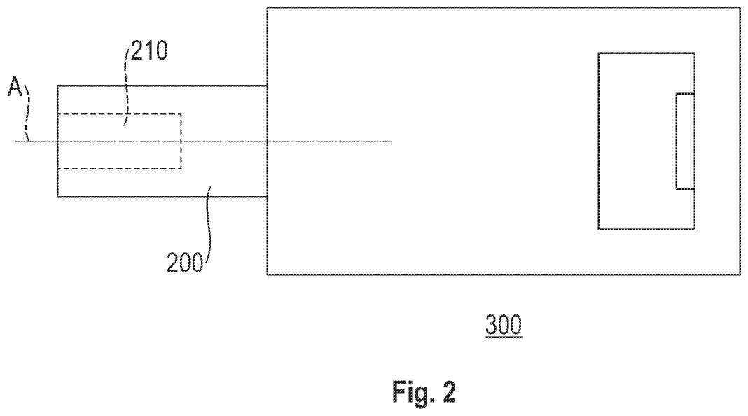

A first preferred exemplary embodiment of a chisel 100 according to the invention is illustrated in FIG. 1. The chisel 100 is intended for use in an electric handheld power tool in the form of a jackhammer 300 (cf. FIG. 2).

The chisel 100 has a free shank 110 via which the chisel 100 can be inserted along a working axis A into an insertion sleeve 210 (cf. FIG. 2) of a tool fitting 200 of the jackhammer 300. As can be gathered from FIG. 1, the free shank 110 has a hexagonal cross section 115. A total of six guide segments 120, which modify the hexagonal cross section 115 and each extend along the working axis A, are formed on a surface OF of the free shank 110. The six guide segments 120 are arranged uniformly along the circumferential direction UR on the shank 110. On the basis of the perspective illustration, only three of the guide segments can be seen in FIG. 1.

The six guide segments 120 each have a planar surface EOF which, with respect to the working axis A, each extend in the tangential direction TR. In the circumferential direction UR, each of the six guide segments 120 is placed centrally over an edge of the hexagonal cross section 115. Consequently, the hexagonal cross section 115 has been modified into a dodecagonal cross section.

As can be gathered from FIG. 1, the free shank 110 has at least one locking groove 140. The locking groove 140 serves for locking the shank 110 in the insertion sleeve 210. Here, the locking groove 140 acts in conjunction with a locking cutout 240 (cf. FIG. 2) in order to limit a movement of the chisel 100 in the axial direction along the working axis A. The locking groove 140 extends parallel to the working axis A.

The chisel 100 of FIG. 1 has a working side 190. The guide segments 120 are arranged only on a side of the locking groove 140 facing away from the working side 190.

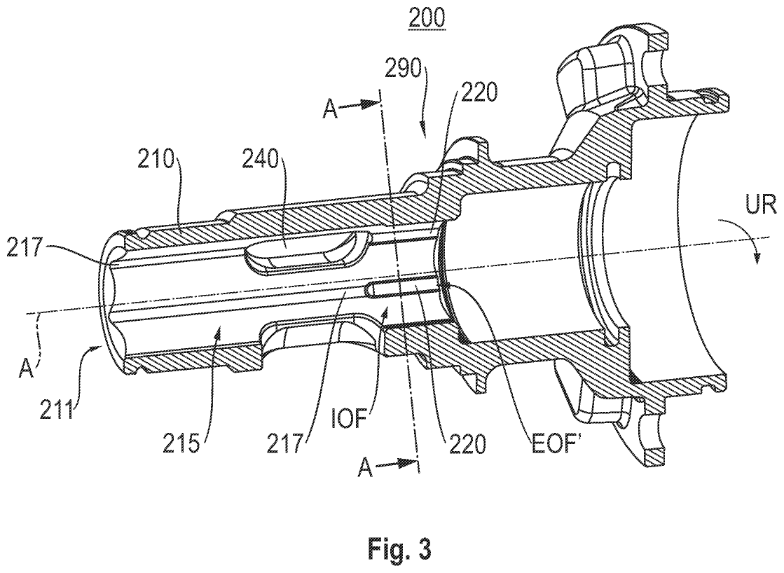

A first preferred exemplary embodiment of a tool fitting 200 according to the invention is illustrated in FIG. 2. Here, FIG. 2 shows a perspective sectional illustration of the tool fitting 200. A cross section of the tool fitting 200 (along the section line A-A in FIG. 3) is illustrated in FIG. 3.

The tool fitting 200 serves for receiving the chisel 100 of FIG. 1 coaxially to a working axis A of the tool fitting 200. The tool fitting 200 has a basic body 290 with an insertion sleeve 210. The chisel 100 can be inserted by a free shank 110 into this insertion sleeve 210. As can be gathered from FIG. 3, the insertion sleeve 210 has a hexagonal cross section 215 at least in certain portions.

Six supporting portions 220, which extend parallel to the working axis A of the tool fitting 100 and which serve to support the free shank 210, are formed on an inner surface IOF of the insertion sleeve 210.

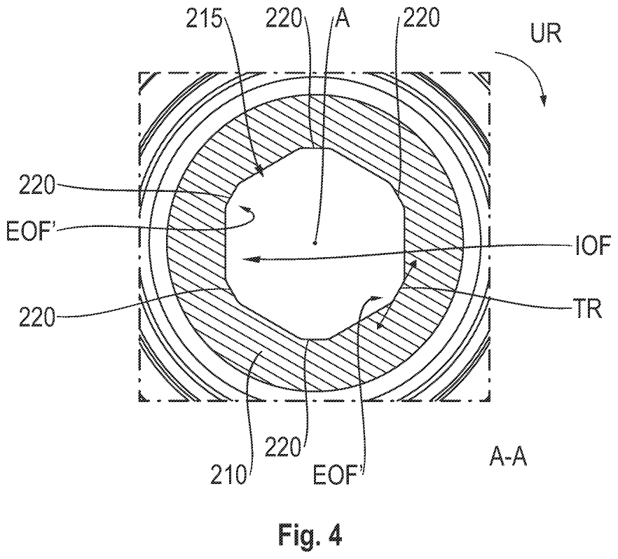

The supporting portions 220 each have a planar surface EOF′ which, with respect to the working axis A, extend in the tangential direction TR and, in the circumferential direction UR, are each placed centrally over an edge 217 of the hexagonal cross section 215. Here, the six supporting portions 220 are arranged uniformly along the circumferential direction UR of the inner surface IOF. Consequently, the hexagonal cross section 115 has been modified into a dodecagonal cross section (cf. FIG. 4).

The insertion sleeve 210 has at least one locking cutout 240 for locking the shank 110 in the insertion sleeve 210, wherein the locking cutout 240 extends parallel to the working axis A. The insertion sleeve 210 is equipped with an inlet opening 211 for the shank 110 of the chisel 100 (cf. FIG. 1). The six supporting portions 220 each extend, with respect to the working axis A, only on that side of the locking cutout 240 which faces away from the inlet opening 211. When the chisel 100 of FIG. 1 is received in the tool fitting 200, the six guide segments 120 are in contact with the six supporting portions 220.

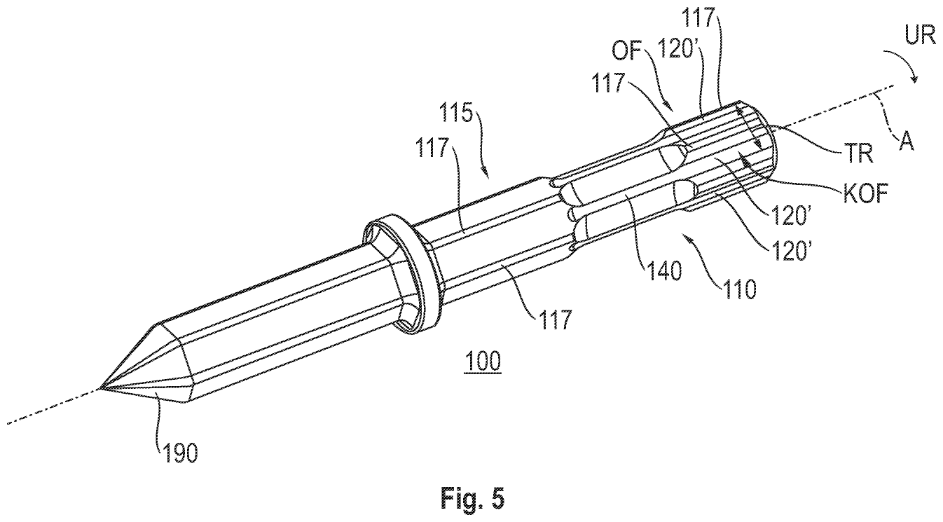

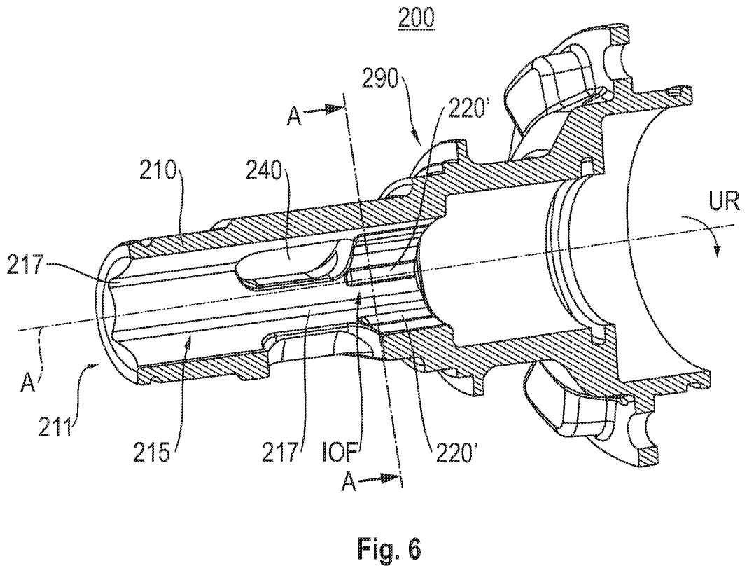

A second preferred exemplary embodiment of a chisel 100 according to the invention is illustrated in FIG. 5. The chisel 100 has a free shank 110 via which the chisel 100 can be inserted along a working axis A into an insertion sleeve 210 (cf. FIG. 6) of a tool fitting 200 of the jackhammer 300. As can be gathered from FIG. 5, the free shank 110 has a hexagonal cross section 115. A total of six guide segments 120′, which modify the hexagonal cross section 115 and each extend along the working axis A, are formed on a surface OF of the free shank 110. The six guide segments 120′ are arranged uniformly along the circumferential direction UR on the shank 110. On the basis of the perspective illustration, only three of the guide segments can be seen in FIG. 5.

By contrast with the exemplary embodiment of FIG. 1, in the exemplary embodiment of FIG. 5 the guide segments 120′ each have a concavely curved surface KOF. Here, the curvatures are each with respect to the working axis A. The concavely curved surfaces KOF are each arranged centrally between two adjacent edges 117 of the hexagonal cross section 115 in the circumferential direction UR. In other words, in the exemplary embodiment of FIG. 5 the guide segments 120′ each take the form of elongate grooves.

As in the exemplary embodiment of FIG. 1, the chisel 100 of FIG. 5 also has a working side 190. By contrast with the exemplary embodiment of FIG. 1, in the exemplary embodiment of FIG. 5 the guide segments 120′, with respect to the working axis A and in a viewing direction from the working side 190 toward the shank 110, already begin at the beginning of the locking groove 140.

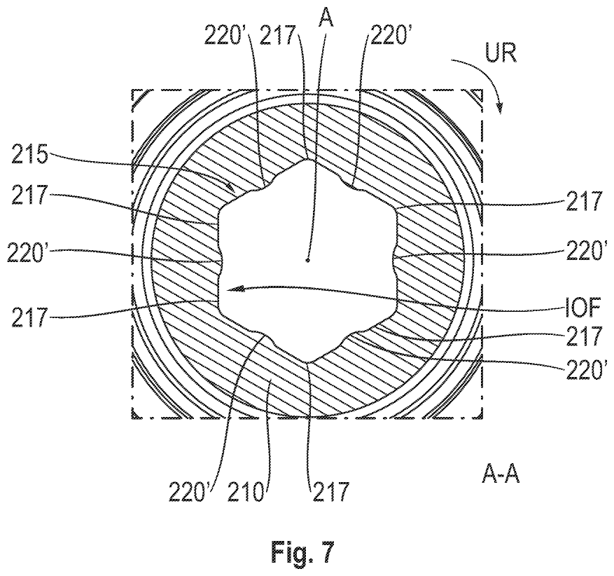

A second preferred exemplary embodiment of a tool fitting 200 according to the invention is illustrated in FIG. 4. Here, FIG. 6 shows a perspective sectional illustration of the tool fitting 200. A cross section of the tool fitting 200 (along the section line A-A in FIG. 6) is shown in FIG. 7.

The tool fitting 200 serves for receiving the chisel 100 of FIG. 3 coaxially to a working axis A of the tool fitting 200. The tool fitting 200 has a basic body 290 with an insertion sleeve 210. The chisel 100 can be inserted by a free shank 110 into this insertion sleeve 210. As can be gathered from FIG. 4, the insertion sleeve 210 has a hexagonal cross section 215 at least in certain portions.

Six supporting portions 220′, which extend parallel to the working axis A of the tool fitting 100 and which serve to support the free shank 210, are formed on an inner surface 10F of the insertion sleeve 210. The supporting portions 220′ each have, with respect to the working axis A, a convexly curved surface KOF′, wherein this surface KOF′ is placed centrally between two adjacent edges 217 of the hexagonal cross section 215 in the circumferential direction UR. In other words, in the exemplary embodiment of FIG. 7 the supporting portions 220′ each take the form of elongate supporting beads. When the chisel 100 of FIG. 5 is received in the tool fitting 200 of FIG. 6, the six guide segments 120′ (in the form of the elongate grooves) are in contact with the six supporting portions 220′ (in the form of the six elongate supporting beads).

### LIST OF REFERENCE SIGNS

100 Chisel
110 Free shank
115 Hexagonal cross section
117 Edge
120, 120′ Guide segment
140 Locking groove
190 Working side
200 Tool fitting
210 Insertion sleeve
211 Inlet opening
215 Hexagonal cross section
217 Edge
220, 220′ Supporting portion
240 Locking cutout
290 Basic body
300 Jackhammer
A Working axis
EOF, EOF′ Planar surface
10F Inner surface
KOF, KOF′ Curved surface
OF Surface
UR Circumferential direction
TR Tangential direction

1-15. (canceled)

16. A chisel comprising:
a free shank, the chisel insertable along a working axis into an insertion sleeve of a tool fitting via the free shank, the free shank having a hexagonal cross section at least in certain portions, and
at least one guide segment modifying the hexagonal cross section and extends along the working axis and formed on a surface of the free shank.

17. The chisel as recited in claim 16 wherein the shank has at least one locking groove for locking the shank in the insertion sleeve, wherein the locking groove extends parallel to the working axis.

18. The chisel as recited in claim 17 wherein the chisel has a working side, and the guide segment, with respect to the working axis and in a viewing direction from the working side toward the shank, begins at the earliest at the extent of the locking groove.

19. The chisel as recited in claim 18 wherein the guide segment is situated only on a side of the locking groove facing away from the working side.

20. The chisel as recited in claim 16 wherein the guide segment has a planar surface extending, with respect to the working axis, tangentially and, in a circumferential direction, is placed centrally over an edge of the hexagonal cross section.

21. The chisel as recited in claim 16 wherein the guide segment has, with respect to the working axis, a concavely curved surface central between two adjacent edges of the hexagonal cross section in a circumferential direction.

22. The chisel as recited in claim 16 wherein six guide segments are arranged uniformly along a circumferential direction on the shank.

23. A tool fitting for receiving a percussive or rotating tool coaxially to a working axis of the tool fitting, the tool fitting comprising:
a basic body with an insertion sleeve, the tool insertable by a free shank into the basic body, the insertion sleeve having a hexagonal cross section at least in certain portions and having at least one supporting portion extending parallel to the working axis of the tool fitting and is formed on an inner surface of the insertion sleeve.

24. The tool fitting as recited in claim 23 wherein the supporting portion is a shank support for the free shank.

25. The tool fitting as recited in claim 23 wherein the insertion sleeve has at least one locking cutout for locking the shank in the insertion sleeve, wherein the locking cutout extends parallel to the working axis.

26. The tool fitting as recited in claim 23 wherein the insertion sleeve has an inlet opening for the shank, and the supporting portion extends, with respect to the working axis, only on that side of the locking cutout which faces away from the inlet opening.

27. The tool fitting as recited in claim 23 wherein the supporting portion has a planar surface extending, with respect to the working axis, tangentially and, in the circumferential direction, is placed centrally over an edge of the hexagonal cross section.

28. The tool fitting as recited in claim 23 wherein the supporting portion has, with respect to the working axis, a convexly curved surface placed centrally between two adjacent edges of the hexagonal cross section in the circumferential direction.

29. The tool fitting as recited in claim 23 wherein the at least one supporting portion includes six supporting portions arranged uniformly along a circumferential direction of the inner surface.

30. The tool fitting as recited in claim 23 wherein the supporting portion is formed in one piece with the insertion sleeve.

31. The tool fitting as recited in claim 23 wherein the insertion sleeve is a chisel receiving sleeve.

32. The chisel as recited in claim 16 wherein the chisel is a jackhammer chisel.

33. An electric handheld power tool comprising the chisel as recited in claim 16.

34. An electric handheld power tool comprising the tool fitting as recited in claim 23.

35. A jackhammer comprising the chisel as recited in claim 16.

36. A jackhammer comprising the tool fitting as recited in claim 23.
